(19) United States
(12) Patent Application Publication
(10) Pub. No.: US 2022/0258108 A1
(43) Pub. Date: Aug. 18, 2022

(54) NANO-BUBBLE GENERATOR

(71) Applicant: Moleaer, Inc, Carson, CA (US)

(72) Inventors: Federico Pasini, Hermosa Beach, CA (US); Bruce Scholten, Carson, CA (US)

(21) Appl. No.: 17/674,547

(22) Filed: Feb. 17, 2022

Related U.S. Application Data
(60) Provisional application No. 63/150,973, filed on Feb. 18, 2021.

(51) Int. Cl. B01F 23/23; B01F 23/2373; B01F 25/314; B01F 23/233

(52) U.S. Cl. CPC B01F 23/238; B01F 23/233; B01F 25/31421; B01F 23/2373

(57) ABSTRACT

A nano-bubble-generating apparatus includes: an elongate housing defining an interior cavity adapted for receiving a liquid carrier, a liquid inlet, and a liquid outlet; a gas-permeable member at least partially disposed within the interior cavity of the housing that includes a first end adapted for receiving a pressurized gas, a second end, and a porous sidewall; and an electrical conductor adapted to generate a magnetic flux parallel to an outer surface of the gas-permeable member as the liquid carrier flows from the liquid inlet to the liquid outlet. The housing and gas-permeable member are configured such that the flow rate of the liquid carrier flowing parallel to the outer surface of the gas-permeable member is greater than the turbulent threshold of the liquid to create turbulent flow conditions, thereby allowing the liquid to shear gas from the outer surface of the gas-permeable member and form nano-bubbles in the liquid carrier.

### CLAIM OF PRIORITY

This application claims priority to U.S. Provisional Application Ser. No. 63/150,973, filed on Feb. 18, 2021, the entire contents of which are hereby incorporated by reference.

### TECHNICAL FIELD

This invention relates to generating nano-bubbles in a liquid carrier.

### BACKGROUND

Nano-bubbles are stable in liquid carriers for extended periods of time, allowing them to be transported without coalescing in the liquid carrier. These properties make nano-bubbles useful in a variety of fields, including water treatment, plant growth, aquaculture, and sterilization.

### SUMMARY

In a first aspect, an apparatus for generating a composition that includes nano-bubbles in a liquid carrier is described. The apparatus includes: (a) an elongate housing that includes a first end and a second end, and defines a liquid inlet, a liquid outlet, and an interior cavity adapted for receiving the liquid carrier from a liquid source; (b) a gas-permeable member at least partially disposed within the interior cavity of the housing that includes a first end adapted for receiving a pressurized gas from a gas source, a second end, and a porous sidewall extending between the first and second ends, the gas-permeable member defining an inner surface, an outer surface, and a lumen; and (c) at least one electrical conductor adapted to generate a magnetic flux parallel to the outer surface of the gas-permeable member as the liquid carrier flows from the liquid inlet to the liquid outlet. The housing and gas-permeable member are configured such that the flow rate of the liquid carrier from the liquid source as it flows parallel to the outer surface of the gas-permeable member from the liquid inlet to the liquid outlet is greater than the turbulent threshold of the liquid to create turbulent flow conditions, thereby allowing the liquid to shear gas from the outer surface of the gas-permeable member and form nano-bubbles in the liquid carrier.

In some embodiments, the gas-permeable member is electrically conductive. The electrical conductor may be an electromagnetic coil (e.g., a stator) or a wire. In some cases, the apparatus includes a pair of electrical conductors, one of which is the gas-permeable member and the other of which is, e.g., an electromagnetic coil or a wire.

In some embodiments, the apparatus includes a helicoidal member adapted to cause the liquid carrier to rotate as it flows from the liquid inlet to the liquid outlet. The helicoidal member may be in the form of a pattern integral to the gas-permeable member, the housing, or both. In other embodiments, the helicoidal member includes an electromagnetic coil adapted to generate a magnetic flux parallel to the outer surface of the gas-permeable member as the liquid carrier flows from the liquid inlet to the liquid outlet. In the latter case, the helicoidal member also performs the role of the electrically conductive member.

The electrical conductor may be located on the exterior of the housing, in the interior cavity of the housing, or on the outer surface of the gas-permeable member. The electrical conductor may also be located downstream or upstream of the gas-permeable member.

The apparatus may further include a hydrofoil located in the interior cavity of the housing. The hydrofoil may be located upstream or downstream of the gas-permeable member. In some embodiments, the hydrofoil is physically attached to the gas-permeable member. The hydrofoil causes the liquid carrier to rotate as it flows past the hydrofoil.

In a second aspect, a second apparatus for producing a composition that includes nano-bubbles dispersed in a liquid carrier is described. The apparatus includes: (a) an elongate housing that includes a first end and a second end, and defines a liquid inlet, a liquid outlet, and an interior cavity adapted for receiving the liquid carrier from a liquid source; (b) a gas-permeable member at least partially disposed within the interior cavity of the housing, the gas-permeable member including a first end adapted for receiving a pressurized gas from a gas source, a second end, and a porous sidewall extending between the first and second ends, the gas-permeable member defining an inner surface, an outer surface, and a lumen; (c) one or more electrodes, one of which is an electromagnetic coil adapted to generate a magnetic flux parallel to the outer surface of the gas-permeable member as the liquid carrier flows from the liquid inlet to the liquid outlet, (d) a helicoidal member adapted to cause the liquid carrier to rotate as it flows from the liquid inlet to the liquid outlet, and (e) a hydrofoil located in the interior cavity of the housing. The housing and gas-permeable member are configured such that the flow rate of the liquid carrier from the liquid source as it flows parallel to the outer surface of the gas-permeable member from the liquid inlet to the liquid outlet is greater than the turbulent threshold of the liquid to create turbulent flow conditions, thereby allowing the liquid to shear gas from the outer surface of the gas-permeable member and form nano-bubbles in the liquid carrier.

In some embodiments, the helicoidal member includes the electromagnetic coil.

In a third aspect, a method for producing a composition including nano-bubbles dispersed in a liquid carrier using the apparatus described in the first and second aspects of the invention is described. The method includes: (a) introducing a liquid carrier from a liquid source into the interior cavity of the housing through the liquid inlet of the housing at a flow rate that creates turbulent flow above the turbulent threshold at the outer surface of the gas-permeable member; (b) applying a magnetic flux parallel to the outer surface of the gas-permeable member as the liquid carrier flows from the liquid inlet to the liquid outlet; and (c) introducing a pressurized gas from a gas source into the lumen of the gas-permeable member at a gas pressure selected such that the pressure within the lumen is greater than the pressure in the interior cavity of the housing, thereby forcing gas through the porous sidewall and forming nano-bubbles on the outer surface of the gas-permeable member. The liquid carrier flowing parallel to the outer surface of the gas-permeable member from the liquid inlet to the liquid outlet removes nano-bubbles from the outer surface of the gas-permeable member to form a composition comprising the liquid carrier and the nano-bubbles dispersed therein.

In some embodiments, the flow rate is at least 2 m/s. The method may include applying an oscillating magnetic flux, e.g., a high frequency oscillating magnetic flux.

In a fourth aspect, a third apparatus for producing a composition including nano-bubbles dispersed in a liquid carrier is described. The apparatus includes: (a) an elongate housing including a first end and a second end, the housing further including an interior cavity and a gas inlet adapted for introducing pressurized gas from a gas source into the interior cavity; (b) a gas-permeable member at least partially disposed within the interior cavity of the housing, the gas-permeable member including a liquid inlet adapted for receiving a liquid from a liquid source, a liquid outlet, and a porous sidewall extending between the liquid inlet and liquid outlet, and defining an inner surface, an outer surface, and a lumen through which liquid flows; and (c) at least one electrical conductor adapted to generate a magnetic flux parallel to the inner surface of the gas-permeable member as the liquid carrier flows from the liquid inlet to the liquid outlet. The housing and gas-permeable member are configured such that the flow rate of the liquid carrier from the liquid source as it flows parallel to the inner surface of the gas-permeable member from the liquid inlet to the liquid outlet is greater than the turbulent threshold of the liquid to create turbulent flow conditions, thereby allowing the liquid to shear gas from the inner surface of the gas-permeable member and form nano-bubbles in the liquid carrier.

In a fifth aspect, a method for producing a composition including nano-bubbles dispersed in a liquid carrier using the apparatus described in the fourth aspect of the invention is described. The method includes: (a) introducing a liquid carrier from a liquid source into the interior cavity of the gas-permeable member through the liquid inlet of the housing at a flow rate that creates turbulent flow above the turbulent threshold at the outer surface of the gas-permeable member; (b) applying a magnetic flux parallel to the inner surface of the gas-permeable member as the liquid carrier flows from the liquid inlet to the liquid outlet; and (c) introducing a pressurized gas from a gas source into the interior cavity of the housing at a gas pressure selected such that the pressure within the interior cavity of the housing is greater than the pressure in the interior of the gas-permeable member, thereby forcing gas through the porous sidewall and forming nano-bubbles on the inner surface of the gas-permeable member. The liquid carrier flowing parallel to the inner surface of the gas-permeable member from the liquid inlet to the liquid outlet removes nano-bubbles from the inner surface of the gas-permeable member to form a composition comprising the liquid carrier and the nano-bubbles dispersed therein.

In some embodiments, the flow rate is at least 2 m/s. The method may include applying an oscillating magnetic flux, e.g., a high frequency oscillating magnetic flux.

In each of the above-described apparatuses and methods, configuring the apparatus such that the flow rate of the liquid carrier from the liquid source as it flows parallel to the inner or outer surface of the gas-permeable member from the liquid inlet to the liquid outlet is greater than the turbulent threshold of the liquid to create turbulent flow conditions minimizes nano-bubble coalescence. Including at least one electrical conductor to generate a magnetic flux (e.g., a high frequency oscillating magnetic flux) parallel to the inner or outer surface of the gas-permeable member as the liquid carrier flows from the liquid inlet to the liquid outlet increases both nano-bubble production and nano-bubble production rate. Measuring the change in resistance of the electrical conductor can be used to detect the presence of nanobubbles in the fluid.

The helicoidal member further increases nano-bubble production and nano-bubble production rate by imparting angular velocity to the liquid carrier to cause swirling, thereby enhancing the efficiency of capturing nano-bubbles at the interface between gas-permeable member and liquid stream. The hydrofoil further increases nano-bubble production and nano-bubble production rate by creating high turbulence regions in the fluid flowing through the apparatus based on the surface of the hydrofoil and the turbulent trailing edge downstream of the hydrofoil.

The apparatuses and methods described above can be used in a variety of applications. Examples include water treatment, e.g., wastewater treatment to oxygenate and/or remove contaminant in a body of water. Other examples include aquaculture and plant growth, where the composition can be used to deliver oxygen or other nutrients. Yet another example is cleaning and sterilization, e.g., in hot tubs or spas to minimize or eliminate the use of chemicals such as chlorine.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a top view of an example apparatus for producing a composition comprising nano-bubbles dispersed in a liquid carrier.

FIG. 1B is a cross-sectional side view of the apparatus of FIG. 1A.

FIG. 1C is an exploded view of the apparatus of FIG. 1A.

FIG. 2A is a top view of an example apparatus for producing a composition comprising nano-bubbles dispersed in a liquid carrier.

FIG. 2B is a cross-sectional side view of the apparatus of FIG. 2A.

FIG. 3A is a top view of an example apparatus for producing a composition comprising nano-bubbles dispersed in a liquid carrier.

FIG. 3B is a cross-sectional side view of the apparatus of FIG. 3A.

FIG. 4A is a top view of an example apparatus for producing a composition comprising nano-bubbles dispersed in a liquid carrier.

FIG. 4B is a cross-sectional side view of the apparatus of FIG. 4A.

FIG. 5A is a top view of an example apparatus for producing a composition comprising nano-bubbles dispersed in a liquid carrier.

FIG. 5B is a cross-sectional side view of the apparatus of FIG. 5A.

FIG. 6A is a top view of an example apparatus for producing a composition comprising nano-bubbles dispersed in a liquid carrier.

FIG. 6B is a cross-sectional side view of the apparatus of FIG. 6A.

FIG. 7 is a top view of an example apparatus for producing a composition comprising nano-bubbles dispersed in a liquid carrier.

FIG. 8 is a top view of an example apparatus for producing a composition comprising nano-bubbles dispersed in a liquid carrier.

FIG. 9A is a perspective view of an example hydrofoil.

FIG. 9B is a side view of the hydrofoil of FIG. 9A.

FIG. 9C is a top view of the hydrofoil of FIG. 9A.

FIG. 10A is a top view of an example mount coupled to the hydrofoil of FIG. 9A.

FIG. 10B is a cross-section of the mount of FIG. 10A that excludes the hydrofoil for illustrative purposes.

FIG. 10C is a cross-section of the mount of FIG. 10A coupled to the hydrofoil of FIG. 9A.

FIG. 11 is a schematic diagram of an example permeable member.

FIG. 12 is a schematic diagram of an example apparatus.

Like reference symbols in the various drawings indicate like elements.

### DETAILED DESCRIPTION

This disclosure describes an apparatus for producing nano-bubbles in a liquid carrier. The nano-bubbles have diameters less than one micrometer (μm). In some embodiments, the nano-bubbles have diameters less than or equal to 500 nanometers (nm). In some embodiments, the nano-bubbles have diameters less than or equal to 200 nanometers (nm).

The apparatuses and methods described herein selectively apply a combination of super-cavitation, vorticity, and/or a magnetic field (preferably a high frequency oscillating magnetic field) in addition to shear to form nano-bubbles in a liquid carrier.

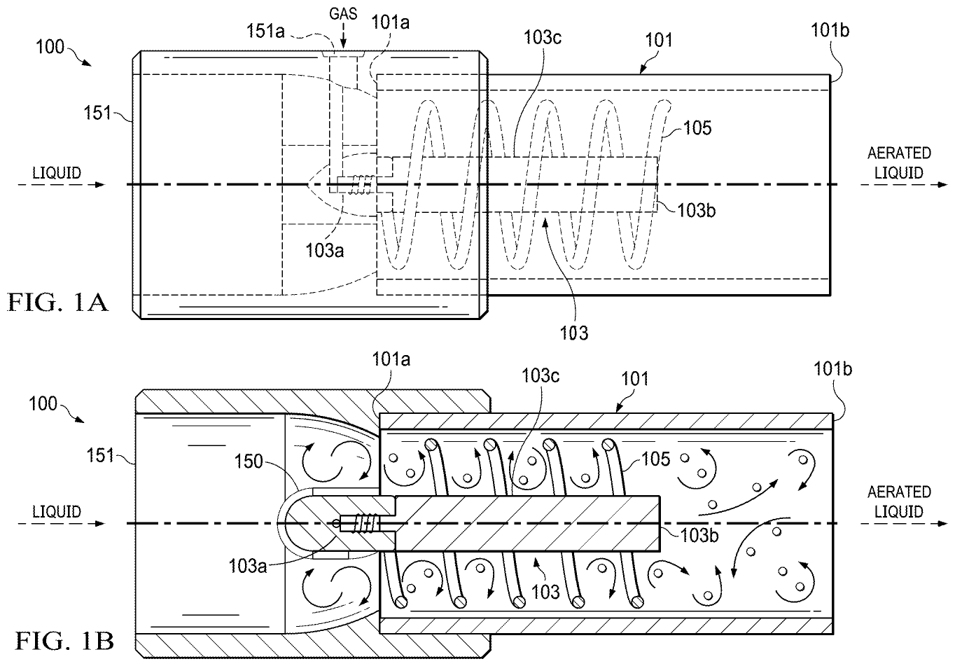

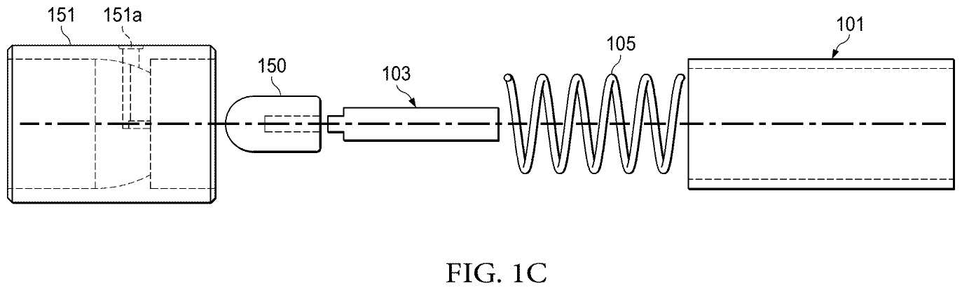

FIGS. 1A and 1B are schematic diagrams showing a top view and a cross-sectional side view, respectively, of an exemplary apparatus 100. FIG. 1C is a schematic diagram showing an exploded view of the apparatus 100 in which the components of the apparatus 100 are shown separated from each other. The apparatus 100 includes a housing 101, a permeable member 103, and an electrical conductor 105. The elongate housing 101 is defined by a first end 101a, a second end 101b, and an interior cavity adapted for receiving a liquid carrier from a liquid source. The housing 101 includes an inlet and an outlet. The first end 101a can be the inlet and the second end 101b can be the outlet.

The apparatus 100 includes the gas-permeable member 103 at least partially disposed within the interior cavity of the housing 101. The permeable member 103 defines an inner surface, an outer surface, and a lumen. The permeable member 103 can include a first end 103a adapted for receiving a pressurized gas from a gas source, a second end 103b, and a porous sidewall 103c extending between the first and second ends 103a, 103b. The first end 103a of the permeable member 103 can be an open end and the second end 103b of the permeable member 103 can be a closed end.

The housing 101 and permeable member 103 can be arranged such that the flow rate of the liquid carrier from the liquid source, as it flows parallel to the outer surface of the permeable member 103 from the liquid inlet to the liquid outlet, is greater than the turbulent threshold of the liquid to create turbulent flow conditions, thereby allowing the liquid to shear gas from the outer surface of the gas-permeable member and form nano-bubbles in the liquid carrier.

As shown in FIGS. 1A-C, the apparatus 100 includes an electrical conductor 105 in the form of a helicoidal member (e.g., a helical electrode) that is located in the interior cavity of the housing 101. The electrical conductor 105 is adapted to generate a magnetic flux parallel to the outer surface of the permeable member 103 as the liquid carrier flows from the liquid inlet to the liquid outlet of the housing 101. Preferably, the electrical conductor 105 is adapted to generate a high frequency oscillating magnetic flux.

The electrical conductor 105 can be located on the outer surface of the permeable member 103. The electrical conductor 105 can surround at least a portion of the permeable member 103. The electrical conductor 105 can also be implemented in other forms. For example, in some embodiments, the electrical conductor 105 includes a wire. In some embodiments, the electrical conductor 105 includes one or more electrodes. In some embodiments, the electrical conductor 105 is in the form of an electromagnetic coil (e.g., a stator). In some embodiments, the permeable member 103 can serve as the electrical conductor 105.

In some embodiments, the apparatus 100 is connected to a source of liquid that provides the liquid carrier (for example, water). In some embodiments, the source of liquid is a vessel or body of water connected to a pump via a suction line. In some embodiments, the pump is a variable speed pump. In some embodiments, the pump is connected to the apparatus 100 via a discharge line with a control valve. In some embodiments, the discharge line is in fluid communication with the housing 101. For example, the liquid carrier flows from the pump, through the control valve, through the discharge line, and to the first end 101a. The percent opening of the control valve can be adjusted to control the pressure and flow rate of the liquid carrier to the apparatus 100.

The apparatus 100 can optionally include a hydrofoil 150 shaped to induce rotation in the liquid carrier flowing through the apparatus 100. In some embodiments, the hydrofoil 150 is shaped (e.g., with tapered and/or curved surfaces) to induce super-cavitation in the liquid carrier flowing through the apparatus 100. For example, the hydrofoil 150 can be shaped to create high turbulence regions in the fluid flowing through the apparatus 100 based on the surface of the hydrofoil 150 and the turbulent trailing edge downstream of the hydrofoil 150. In this disclosure, the terms “downstream” and “upstream” are in relation to the overall flow direction of the liquid carrier, for example, through the apparatus 100. For example, in FIGS. 1A-B, the overall flow direction of the liquid carrier through the apparatus 100 is from left to right, so “downstream” correlates to “to the right of” and “upstream” correlates to “to the left of.”

As shown in FIG. 1B, the hydrofoil 150 can be located in the interior cavity of the housing 101. At least a portion of the hydrofoil 150 can be located upstream of the permeable member 103. The hydrofoil 150 can be physically attached to the permeable member 103. Other implementations of the hydrofoil can also be contemplated. For example, in some embodiments, at least a portion of the hydrofoil 150 can be located downstream of the permeable member 103. The hydrofoil 150 and one or more other components (such as a helicodial member and/or the electrical conductor 105) can cooperatively induce rotation in the fluid flowing through the apparatus 100.

In some embodiments, the apparatus 100 optionally includes a mount 151. The mount can serve to couple two or more components together in the apparatus. As shown in FIGS. 1A-B, the permeable member 103 and, optionally, the hydrofoil 150, can be coupled to the mount 151. The housing 101 can be coupled to the mount 151, for example, the first end 101a of the housing 101 can be coupled to the mount 151. Various means for coupling components together can be applied. For example, the first end 101a of the housing 101 can engage with an inner bore of the mount 151. The mount 151 can provide fluid inlet and/or outlet ports into its coupled components. For example, the mount 151 can define a port 151a that is in fluid communication with the first end 103a of the permeable member 103. The port 151 can be used to introduce gas into the permeable member 103.

The apparatus 100 is connected to a source of gas. As discussed above, the source of gas can be connected to the port 151a (defined by the mount 151), which is in fluid communication with the first end 103a of the permeable member 103. The gas can flow to the first end 103a and into the lumen of the permeable member 103. As the gas flows from the lumen and through the pores of the permeable member 103, nano-bubbles can be formed and sheared from the outer surface of the permeable member 103 by the liquid carrier flowing across the outer surface of the permeable member 103 at a flow rate above the turbulent threshold of the liquid.

In some embodiments, the liquid carrier containing the nano-bubbles formed by the apparatus 100 flows out of the apparatus 100 (for example, out of the second end 101b) to a discharge line. In some embodiments, the liquid carrier containing the nano-bubbles formed by the apparatus 100 flows out of the apparatus 100 to multiple selectable discharge lines (for example, in a vessel or body of water).

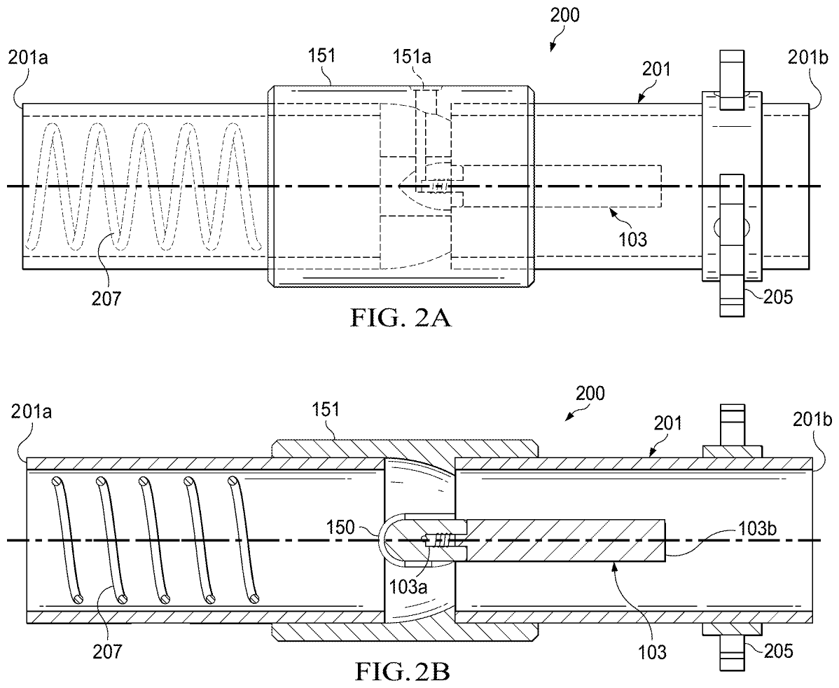

FIGS. 2A and 2B are schematic diagrams of an exemplary apparatus 200. Although apparatus 200 includes one or more of the same features (e.g., permeable member 103, mount 151) of apparatus 100, there are also several distinctions. For example, apparatus 200 includes a housing 201 that is segmented. The segments of the housing 201 can be coupled by the mount 151. The mount 151 can be located between the first end 201a and the second end 201b of the housing 201.

The apparatus 200 of FIGS. 2A-B also includes multiple electrical conductors 205, 207. Electrical conductor 205 is an electromagnetic coil (e.g., a stator) located on an exterior of the housing 201 downstream of the permeable member 103. Electrical conductor 205 is a helicoidal member 207 (e.g., coil electrode) located in the interior cavity of the housing 201 upstream from the permeable member 103. The helicoidal member 207 can include a helical baffle (or a coiled wire) positioned along an inner circumferential wall of the housing 201. The helicoidal member 207 is adapted to cause the liquid carrier to rotate as it flows through the apparatus 200 (for example, from the liquid inlet to the liquid outlet). Similar to the electrical conductor 105 of apparatus 100, the helicoidal member 207 can also serve as an electromagnetic coil adapted to generate a magnetic flux (e.g., a high frequency oscillating magnetic field) parallel to the outer surface of the permeable member 103 as the liquid carrier flows through the apparatus 200 (for example, from the liquid inlet to the liquid outlet).

In some embodiments, the helicoidal member 207 can be an integral feature of the permeable member 103, the housing 201, or both, that causes the liquid carrier to rotate. For example, the helicoidal member 207 can include one or more surface features on a wall of the permeable member 103, the housing 201, or both, that causes the liquid carrier flowing adjacent to the surface to rotate. The surface features may include cavities and/or protrusions on a wall. For example, the helicoidal member 207 can include a helical-shaped surface formed along an inner wall of the housing in some embodiments.

The apparatuses provided herein can include various electrical conductor configurations. In some embodiments, one or more electrical conductors (e.g., electrical conductor 205 or helicoidal member 207) are separate components within the apparatus 200. For example, the electrical conductor 205 and the helicoidal member 207 can be separate components coupled directly to the housing 201 (as shown in FIGS. 2A-B), or spaced apart from the housing 201 (as shown in FIGS. 1A-B). For example, the helicoidal member 207 can be in the form of a helical baffle coupled to and disposed about an outer surface of the permeable member 103. In some embodiments, at least a portion of the one or more electrodes can be positioned upstream, downstream, or at the same approximate location of the permeable member 103.

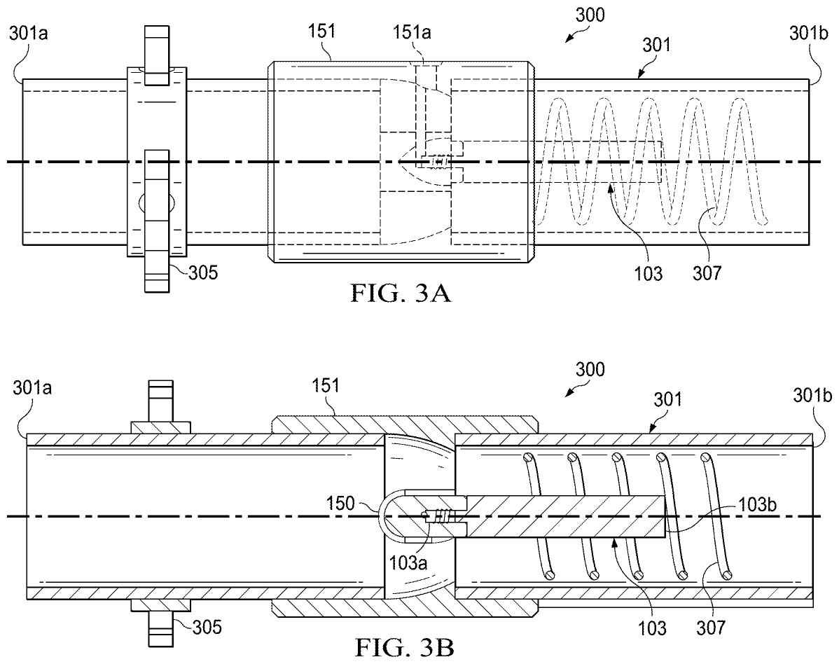

FIGS. 3A and 3B show another exemplary apparatus 300. While apparatus 300 includes some same features (e.g., permeable member 103) of previously discussed apparatuses (e.g., apparatuses 100, 200), this section focuses on the distinctions present in apparatus 300. For example, apparatus 300 has multiple electrical conductors located within the housing 301, including an electrical stator 305 located upstream of the permeable member 103 and a helicoidal member 307 that surrounds at least a portion of the permeable member 103. The helicoidal member 307 can be sized as desired. For example, the helicoidal member 307 of apparatus 300 is longer than the permeable member 103 such that a portion of the helicoidal member 307 extends downstream of the permeable member 103. In some embodiments, the helicodial member 307 can be longer, shorter, or the same approximate length of the permeable member along a longitudinal direction.

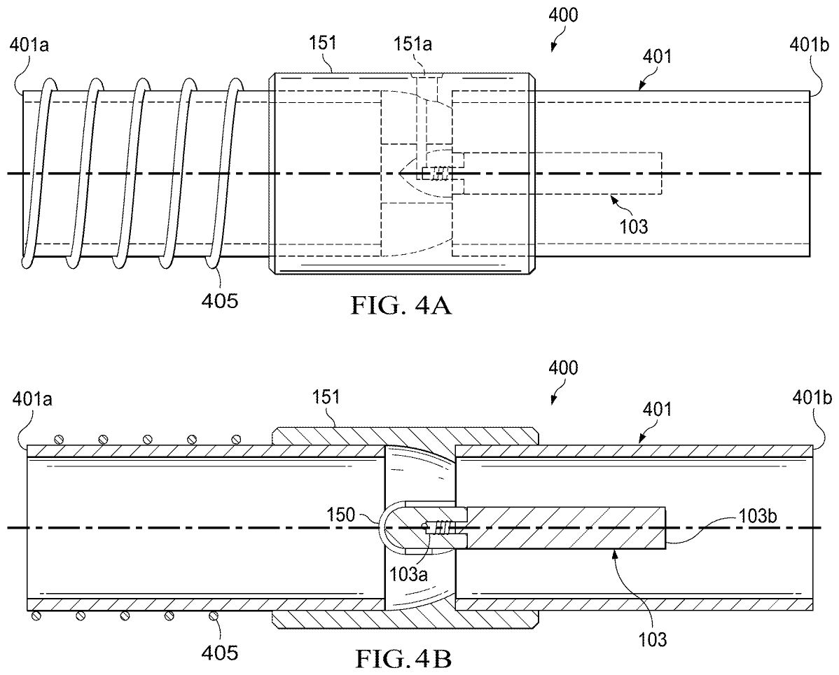

FIGS. 4A and 4B show another exemplary apparatus 400. While apparatus 400 includes some same features (e.g., permeable member 103) of previously discussed apparatuses (e.g., apparatuses 100, 200, 300), this section focuses on the distinctions present in apparatus 400. For example, apparatus 400 includes an electrical conductor 405 in the form of a helicoidal member (e.g., a helical electrode) located on an exterior of the housing 401. For example, the electrical conductor 405 can include a coiled wire (or just a coil) that is coupled directly to and disposed about around the exterior of the housing 401. The electrical conductor 405 of apparatus 400 is located upstream of the permeable member 103. In some embodiments, at least a portion of the electrical conductor 405 can be located downstream or at the same approximate location of the permeable member 103. In some embodiments, the electrical conductor can be disposed on the mount 405.

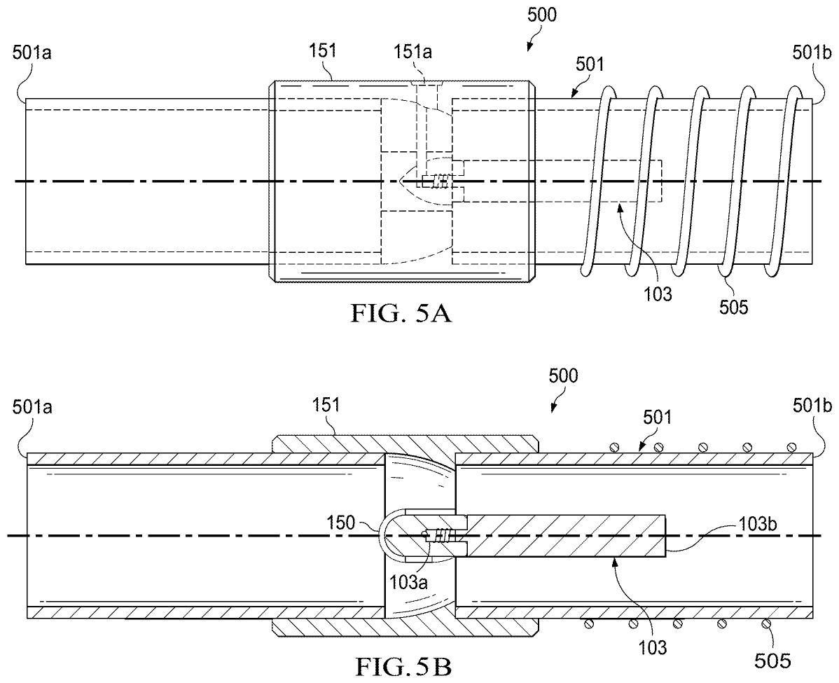

FIGS. 5A and 5B show another exemplary apparatus 500. Apparatus 500 includes some similar features (e.g., permeable member 103) of previously discussed apparatuses (e.g., apparatuses 100, 200, 300, 400), but this section focuses on the distinctions present in apparatus 500. Apparatus 500 includes an electrical conductor 505 in the form of a helicoidal member (e.g., a helical electrode) located on an exterior of the housing 501 positioned generally downstream of the permeable member 103 near an outlet end 501b of the housing 501.

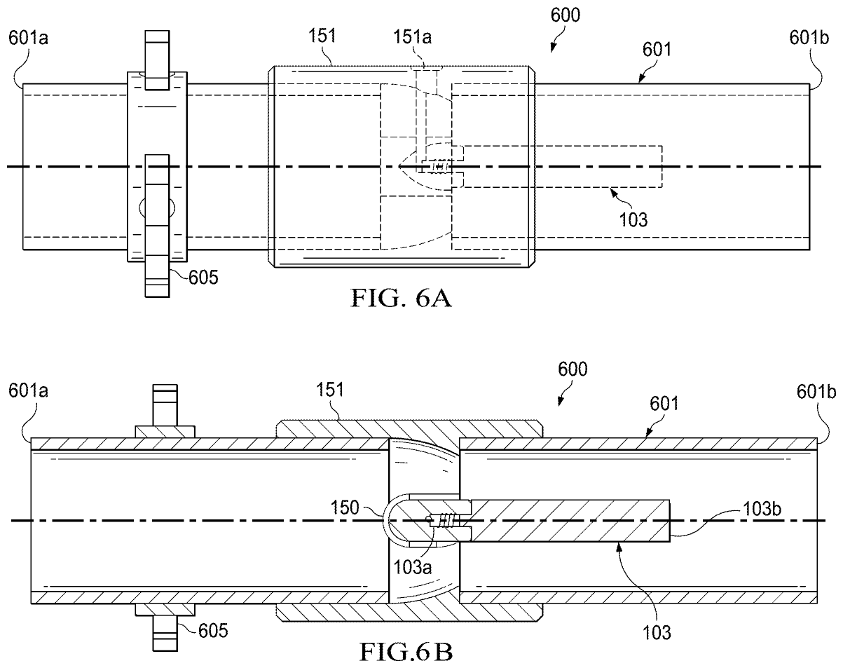

FIGS. 6A and 6B show another exemplary apparatus 600. Apparatus 600 includes some similar features (e.g., permeable member 103) of previously discussed apparatuses (e.g., apparatuses 100, 200, 300, 400, 500), but this section focuses on the distinctions present in apparatus 600. The electrical conductor 605 of apparatus 600 includes an electromagnetic coil (e.g., stator) located on an exterior of the housing 601 and is located upstream of the permeable member 103 near a housing inlet 601a.

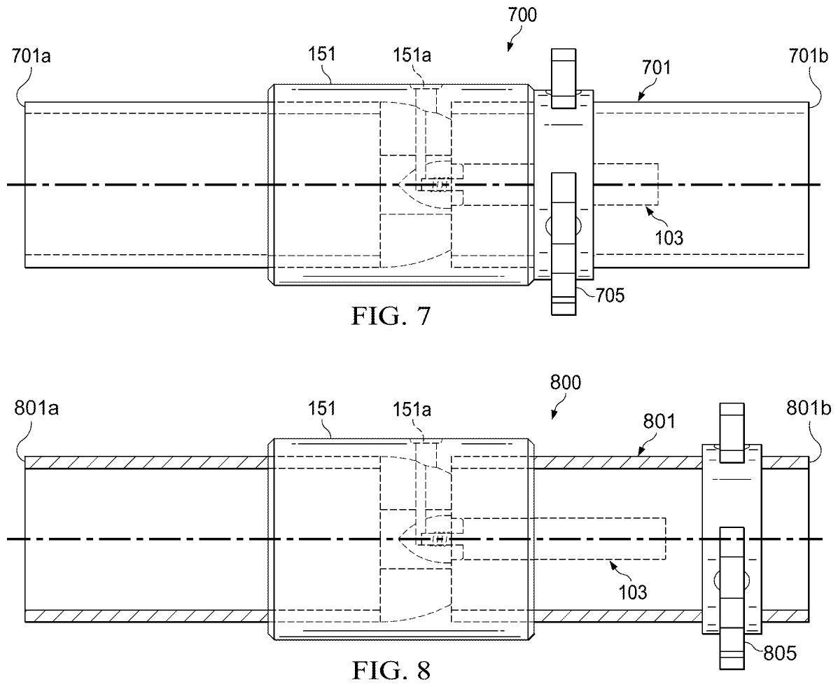

FIG. 7 shows another exemplary apparatus 700. Apparatus 700 includes an electrical conductor 705 in the form of an electromagnetic coil (e.g., stator) located on an exterior of the housing 701. The electrical conductor 705 of apparatus 700 is located at the same approximate location of the permeable member and surrounds a portion of the permeable member 103.

FIG. 8 shows another exemplary apparatus 800 that includes an electrical conductor 105, an electromagnetic coil (e.g., stator), located on an exterior of the housing 801 downstream of the permeable member 103.

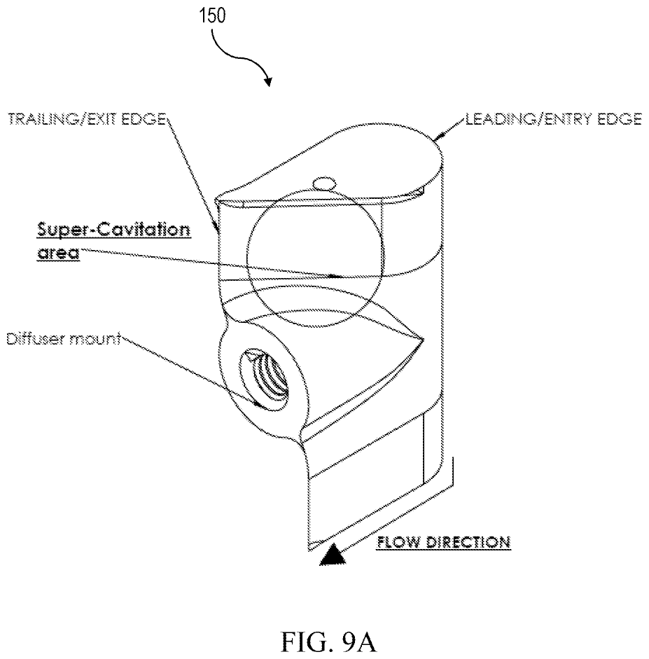

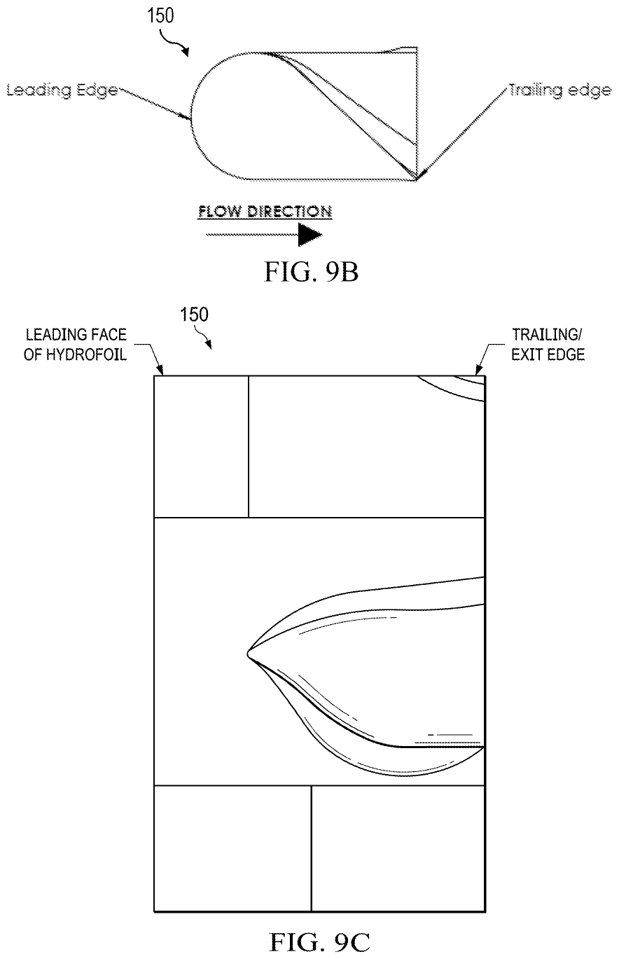

FIGS. 9A-C show an exemplary hydrofoil 150. The hydrofoil includes an asymmetrical shape that is configured to create turbulence in the flow of fluid (for example, the liquid carrier) downstream of the hydrofoil 150. The shape of the hydrofoil 150 can include curved wings (a pair of tapered ends) that are offset from one another that induces rotation in the fluid flowing around the hydrofoil. The hydrofoil 150 can optionally include a coupling element (e.g., threaded female portion in a diffuser mount shown in FIG. 9A)) that is coupleable to the first end 103a of the permeable member 103. The shape of the hydrofoil 150 can induce rotation in the fluid flowing through the apparatus 100 and causes the fluid to swirl (for example, in a helical manner) around the permeable member 103 of FIGS. 1A-B. While the description of the hydrofoil 150 is described above with respect to apparatus 100, the same concepts can be applied to any of the apparatuses 200, 300, 400, 500, 600, 700, or 800 described herein.

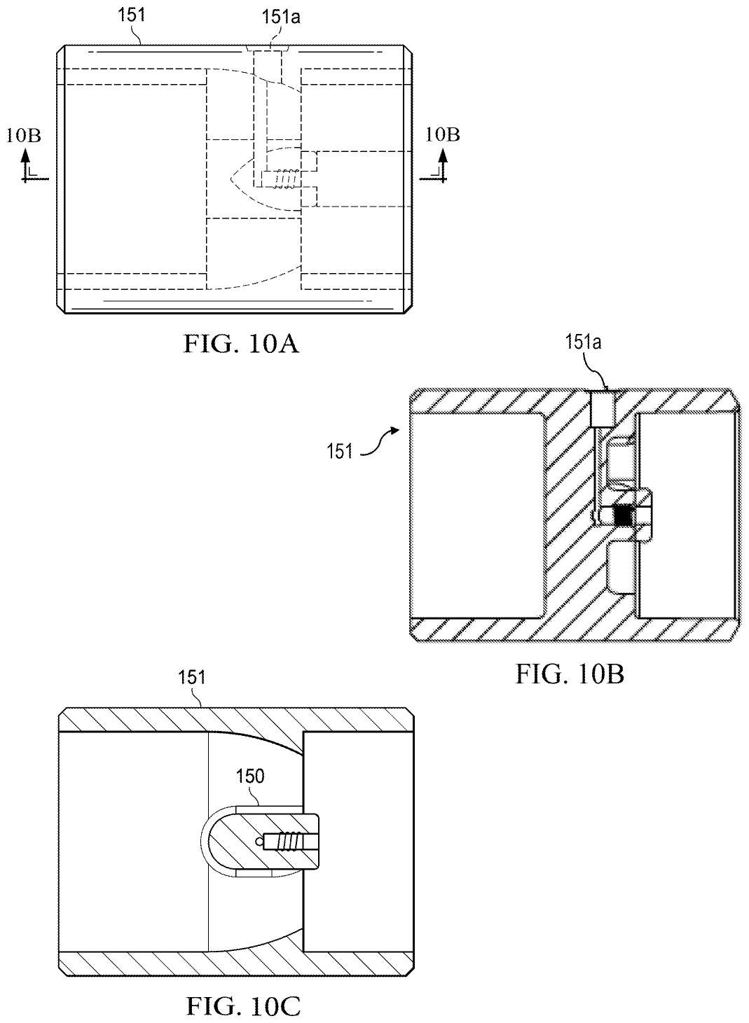

FIGS. 10A-C show an exemplary mount 151 that can be optionally included the apparatus described herein. As discussed above, the mount can be coupled to one or more components of the apparatus described herein, e.g., the hydrofoil 150 of FIGS. 1A-B.

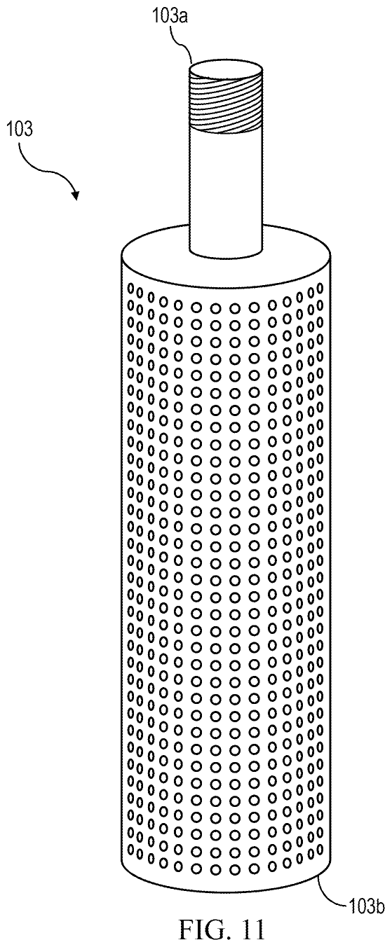

FIG. 11 is a schematic diagram of an exemplary gas-permeable member 103 that can be implemented in the any one of the apparatuses described herein. The permeable member 103 defines multiple pores through which gas can pass through to generate the nano-bubbles. Each of the pores can have a diameter that is less than or equal to 50 μm. In some embodiments, each of the pores have a diameter that is in a range of from 200 nm to 50 μm. The pores can be of uniform size or varying size. The pores can be uniformly or randomly distributed across a surface (e.g., outer surface) of the permeable member 103. The pores can have any regular (e.g., circular) or irregular shape. In some embodiments, the permeable member 103 is electrically conductive and serves as an elongated electrode.

Gas can be flowed into the permeable member 103 such that as liquid flows around the outer surface of the permeable member 103, the gas flows from the lumen of the permeable member 103 through the pores to generate nano-bubbles along the surfaces of the permeable member 103. The liquid flowing around the permeable member 103 shears the nano-bubbles from the permeable member to yield a nano-bubble enriched liquid.

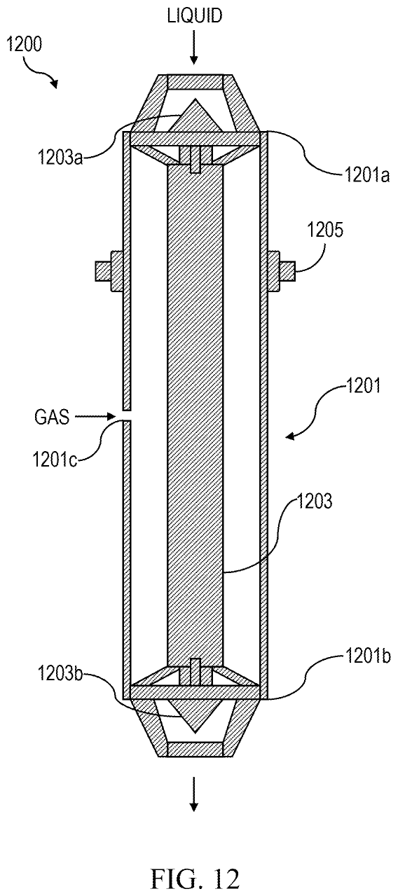

FIG. 12 is a schematic diagram of an exemplary apparatus 1200. Unlike previous exemplary apparatuses, apparatus 1200 includes a housing 1201 adapted to receive a gas from a gas source and a permeable member 1203 adapted to receive a liquid carrier from a liquid source. The permeable member 1203 can be substantially similar to the permeable member 103 (shown in FIG. 11). Liquid is flowed into the permeable member 1203 and gas flows around an outer surface of the permeable member 1203 in apparatus 1200. Gas flows into the lumen of the permeable member 1203 through the pores to generate nano-bubbles that are sheared and dispersed into the liquid flowing within the permeable member 1203.

The housing 1201 of apparatus 1200 includes a first end 1201a and a second end 1201b that are closed ends. A gas flows from a source through a port 1201c defined by the housing 1201 into an interior cavity of the housing 1201. Although shown in FIG. 12 as being located near the middle of the housing 1201, the port 1201c can be located at any point of the housing 1201, as long as the port 1201c provides an entry point for gas to enter the interior cavity of the housing 1201.

The permeable member 1203 has a first end 1203a that can serve as a liquid inlet adapted for receiving a liquid carrier. The permeable member 1203 includes pores that allow a gas to pass through its walls. The permeable member 1203 is enclosed within the interior cavity of the housing 1201 such that the gas within the housing flows across the walls of the permeable member 1203. Pressure is applied to flow gas through the pores of the permeable member 1203 and into the lumen of the permeable member 1203. As the gas flows through the pores of the permeable member 1203, nano-bubbles are formed. The liquid carrier flowing through the lumen of the permeable member 1203 shears the nano-bubbles from an inner surface of the permeable member 1203 as they form. The second end 1203b of the permeable member 1203 can be an open end or an outlet for discharging the liquid carrier carrying formed nano-bubbles.

The apparatus 1200 of FIG. 12 includes an electrical conductor 1205 in the form of an electromagnetic coil (e.g., stator) located on an exterior of the housing 1201. The electrical conductor 1205 surrounds at least a portion of the permeable member 1203 and is located upstream of the port 1201c. One or more electrical conductors can be implemented in a variety of ways, as described in sections above.

Apparatus 1200 can optionally include a component (e.g., helicoidal member and/or a hydrofoil) to induce rotation in the liquid flowing through the permeable member 1203, as described previously herein. The optional component can be located in the interior cavity of the housing 1201. For example, the optional component can be coupled to the permeable member 1203. In some embodiments, the optional component is integral to the permeable member 1203. For example, the optional component can be a helicoidal member that includes a helical baffle or coil disposed about an inner surface of the permeable member 1203. In some embodiments, at least a portion of the optional component is located upstream or downstream of the permeable member 1203. In some embodiments, apparatus 1200 includes the hydrofoil, the helicoidal member, and/or the electrical conductor 1205, which can cooperatively induce rotation in the fluid flowing through the apparatus 1200.

Any of the apparatuses and methods described herein include producing nano-bubbles having a mean diameter less than 1 μm in a liquid volume. In some embodiments, the nano-bubbles have a mean diameter ranging from about 10 nm to about 500 nm, about 75 nm to about 200 nm, or about 50 nm to about 150 nm. The nano-bubbles in the composition may have a unimodal distribution of diameters, where the mean bubble diameter is less than 1 μm. In some embodiments, any of the compositions produced by the apparatuses and methods described herein include nano-bubbles, but are free of micro-bubbles.

Particular embodiments of the subject matter have been described. Nevertheless, it will be understood that various modifications, substitutions, and alterations may be made.

What is claimed is:

1. An apparatus for producing a composition comprising nano-bubbles dispersed in a liquid carrier, the apparatus comprising:
(a) an elongate housing comprising a first end and a second end, the housing defining a liquid inlet, a liquid outlet, and an interior cavity adapted for receiving the liquid carrier from a liquid source;
(b) a gas-permeable member at least partially disposed within the interior cavity of the housing, the gas-permeable member comprising a first end adapted for receiving a pressurized gas from a gas source, a second end, and a porous sidewall extending between the first and second ends, the gas-permeable member defining an inner surface, an outer surface, and a lumen;
(c) at least one electrical conductor adapted to generate a magnetic flux parallel to the outer surface of the gas-permeable member as the liquid carrier flows from the liquid inlet to the liquid outlet,
the housing and gas-permeable member being configured such that the flow rate of the liquid carrier from the liquid source as it flows parallel to the outer surface of the gas-permeable member from the liquid inlet to the liquid outlet is greater than the turbulent threshold of the liquid to create turbulent flow conditions, thereby allowing the liquid to shear gas from the outer surface of the gas-permeable member and form nano-bubbles in the liquid carrier.

2. The apparatus of claim 1, wherein the gas-permeable member is electrically conductive.

3. The apparatus of claim 1, wherein the electrical conductor comprises an electromagnetic coil.

4. The apparatus of claim 3, wherein the electromagnetic coil comprises a stator.

5. The apparatus of claim 1, wherein the electrical conductor comprises a wire.

6. The apparatus of claim 1, comprising a helicoidal member adapted to cause the liquid carrier to rotate as it flows from the liquid inlet to the liquid outlet.

7. The apparatus of claim 6, wherein the helicoidal member is in the form of a pattern integral to the gas-permeable member, the housing, or both.

8. The apparatus of claim 7, wherein the helicoidal member comprises an electromagnetic coil adapted to generate a magnetic flux parallel to the outer surface of the gas-permeable member as the liquid carrier flows from the liquid inlet to the liquid outlet.

9. The apparatus of claim 1, wherein the electrical conductor is located on the exterior of the housing.

10. The apparatus of claim 1, wherein the electrical conductor is located in the interior cavity of the housing.

11. The apparatus of claim 1, wherein the electrical conductor is located on the outer surface of the gas-permeable member.

12. The apparatus of claim 1, wherein the electrical conductor is located downstream of the gas-permeable member.

13. The apparatus of claim 1, wherein the electrical conductor is located upstream of the gas-permeable member.

14. The apparatus of claim 1, further comprising a hydrofoil located in the interior cavity of the housing.

15. The apparatus of claim 14, wherein the hydrofoil is located upstream of the gas-permeable member.

16. The apparatus of claim 14, wherein the hydrofoil is located downstream of the gas-permeable member.

17. The apparatus of claim 1, wherein the hydrofoil is physically attached to the gas-permeable member.

18. An apparatus for producing a composition comprising nano-bubbles dispersed in a liquid carrier, the apparatus comprising:
(a) an elongate housing comprising a first end and a second end, the housing defining a liquid inlet, a liquid outlet, and an interior cavity adapted for receiving the liquid carrier from a liquid source;
(b) a gas-permeable member at least partially disposed within the interior cavity of the housing, the gas-permeable member comprising a first end adapted for receiving a pressurized gas from a gas source, a second end, and a porous sidewall extending between the first and second ends, the gas-permeable member defining an inner surface, an outer surface, and a lumen;
(c) one or more electrical conductors, one of which comprises an electromagnetic coil adapted to generate a magnetic flux parallel to the outer surface of the gas-permeable member as the liquid carrier flows from the liquid inlet to the liquid outlet,
(d) a helicoidal member adapted to cause the liquid carrier to rotate as it flows from the liquid inlet to the liquid outlet, and
(e) a hydrofoil located in the interior cavity of the housing,
the housing and gas-permeable member being configured such that the flow rate of the liquid carrier from the liquid source as it flows parallel to the outer surface of the gas-permeable member from the liquid inlet to the liquid outlet is greater than the turbulent threshold of the liquid to create turbulent flow conditions, thereby allowing the liquid to shear gas from the outer surface of the gas-permeable member and form nano-bubbles in the liquid carrier.

19. The apparatus of claim 18, wherein the helicoidal member comprises the electromagnetic coil.

20. A method for producing a composition comprising nano-bubbles dispersed in a liquid carrier using the apparatus of claim 1, the method comprising:
(a) introducing a liquid carrier from a liquid source into the interior cavity of the housing through the liquid inlet of the housing at a flow rate that creates turbulent flow above the turbulent threshold at the outer surface of the gas-permeable member;
(b) applying a magnetic flux parallel to the outer surface of the gas-permeable member as the liquid carrier flows from the liquid inlet to the liquid outlet; and
(c) introducing a pressurized gas from a gas source into the lumen of the gas-permeable member at a gas pressure selected such that the pressure within the lumen is greater than the pressure in the interior cavity of the housing, thereby forcing gas through the porous sidewall and forming nano-bubbles on the outer surface of the gas-permeable member,
wherein the liquid carrier flowing parallel to the outer surface of the gas-permeable member from the liquid inlet to the liquid outlet removes nano-bubbles from the outer surface of the gas-permeable member to form a composition comprising the liquid carrier and the nano-bubbles dispersed therein.

21. The method of claim 20, comprising applying an oscillating magnetic flux parallel to the outer surface of the gas-permeable member.

22. The method of claim 21, comprising applying a high frequency oscillating magnetic flux parallel to the outer surface of the gas-permeable member.

23. An apparatus for producing a composition comprising nano-bubbles dispersed in a liquid carrier, the apparatus comprising:
(a) an elongate housing comprising a first end and a second end, the housing further comprising an interior cavity and a gas inlet adapted for introducing pressurized gas from a gas source into the interior cavity;
(b) a gas-permeable member at least partially disposed within the interior cavity of the housing, the gas-permeable member comprising a liquid inlet adapted for receiving a liquid from a liquid source, a liquid outlet, and a porous sidewall extending between the liquid inlet and liquid outlet, the gas-permeable member defining an inner surface, an outer surface, and a lumen through which liquid flows;
(c) at least one electrical conductor adapted to generate a magnetic flux parallel to the inner surface of the gas-permeable member as the liquid carrier flows from the liquid inlet to the liquid outlet,
the housing and gas-permeable member being configured such that the flow rate of the liquid carrier from the liquid source as it flows parallel to the inner surface of the gas-permeable member from the liquid inlet to the liquid outlet is greater than the turbulent threshold of the liquid to create turbulent flow conditions, thereby allowing the liquid to shear gas from the inner surface of the gas-permeable member and form nano-bubbles in the liquid carrier.

24. A method for producing a composition comprising nano-bubbles dispersed in a liquid carrier using the apparatus of claim 23, the method comprising:
(a) introducing a liquid carrier from a liquid source into the interior cavity of the gas-permeable member through the liquid inlet of the housing at a flow rate that creates turbulent flow above the turbulent threshold at the outer surface of the gas-permeable member;
(b) applying a magnetic flux parallel to the inner surface of the gas-permeable member as the liquid carrier flows from the liquid inlet to the liquid outlet; and
(c) introducing a pressurized gas from a gas source into the interior cavity of the housing at a gas pressure selected such that the pressure within the interior cavity of the housing is greater than the pressure in the interior of the gas-permeable member, thereby forcing gas through the porous sidewall and forming nano-bubbles on the inner surface of the gas-permeable member,
wherein the liquid carrier flowing parallel to the inner surface of the gas-permeable member from the liquid inlet to the liquid outlet removes nano-bubbles from the inner surface of the gas-permeable member to form a composition comprising the liquid carrier and the nano-bubbles dispersed therein.

25. The method of claim 24, comprising applying an oscillating magnetic flux parallel to the inner surface of the gas-permeable member.

26. The method of claim 25, comprising applying a high frequency oscillating magnetic flux parallel to the inner surface of the gas-permeable member.
